(19) United States
(12) Patent Application Publication
(10) Pub. No.: US 2010/0040849 A1
(43) Pub. Date: Feb. 18, 2010

(54) Absorbing anti-reflection coatings for lenses

(76) Inventor: William H. Southwell, Thousand Oaks, CA (US)

Correspondence Address: William H. Southwell, 1421 Feather Ave, Thousand Oaks, CA, 91360, US

(21) Appl. No.: 12/228,802

(22) Filed: Aug. 16, 2008

(51) Int. Cl. B32B 7/02; B05D 5/06; C09D 5/00; B32B 15/00

(52) U.S. Cl. 428/212; 427/162; 252/582; 428/457; 428/702

(57) ABSTRACT

A method is provided for the reduction of image noise due to multiple reflections from lens surfaces which incorporates weak absorption into the antireflection coatings of the lens surfaces. Even though weak absorption in the coatings may slightly decrease the transmittance, these special coatings with tailored absorption will increase image contrast and signal to noise ratios. Such coatings may also be designed to reduce image noise from surface scattering as from dust or scratches on the front surface of a lens. Tailored absorption coatings may also be used to reduce back reflection from lens systems

### STATEMENT REGARDING FEDERALLY SPONSORED RESEARCH OR DEVELOPMENT

This invention was made with Government support under subcontract USAF-5408-23-SC-0010-1-F11 awarded to Table Mountain Optics by General Dynamics Information Technology, Inc. under contract F33615-03-D-5408 awarded by U.S. Air Force. The Government has certain rights in the invention.

### REFERENCE TO SEQUENCE LISTING, A TABLE, OR A COMPUTER PROGRAM LISTING COMPACT DISC APPENDIX

“Not Applicable”

### FIELD OF THE INVENTION

This invention relates to the use of absorbing anti-reflection coatings used on single or multi-lens imaging systems. Specially designed coatings with weak absorption of this invention enhance the image contrast and signal to noise ratio by reducing the effects of surface scattering and multiple reflections or ghost images from the lens surfaces.

### BACKGROUND OF THE INVENTION

Uncoated lens suffer from throughput losses from the Fresnel reflection occurring at each surface. In addition to this signal loss such reflections also cause a noise component in the image due to the multiple reflections between the lens surfaces. Light reaching the image from these multiple reflections will be out of focus, appearing as background noise. These are called ghost images and can cause significant degradation to certain regions of the image.

Current art uses anti-reflection coatings on all the lens surfaces. Such coatings are non-absorbing so as to enhance the total transmittance and to reduce the amount of light being multiply reflected. However, anti-reflection coatings cannot reduce the reflection to zero over wide spectral regions such as over the visible band. Some modern optic sensors require imaging in multiple spectral bands where it is even more difficult to obtain ultra low reflection. Furthermore, many sensors deal with low light levels where signal-to-noise becomes an important consideration.

Absorbing anti-reflection coatings are currently being used on display screens such as CRT screens to improve image contrast. See, for example, U.S. Pat. No. 5,858,519, “Absorbing anti-reflection coatings for computer displays,” by Klinger et al. and U.S. Pat. No. 6,358,617, “Light absorptive antireflector and process for its production,” by Ohsaki et al. These coatings reduce the reflection from bright objects in the room where the display is being viewed which significantly improves the contrast. These coatings are applied on only one surface and typically have only 70% transmittance. Such coatings could not be used on multiple lens surfaces as the accumulated signal losses would be prohibitive.

There is therefore a need to provide a means to improve the image contrast and signal-to-noise ratio resulting from noise due to multiple reflections and surface scatter. The present invention addresses this need. I have discovered that optical coatings that have the property that light is reflected more when incident from one direction than the other may be used to reduce the amount of multiply reflected light that reaches the image surface. This directly increases image contrast and signal-to-noise.

### BRIEF SUMMARY OF THE INVENTION

The system under consideration consists of the surfaces of the lenses of an optical imaging system and the anti-reflection coatings that are placed on those surfaces. As light is incident upon the first surface, for example, part of the incident light is reflected, part of it may be scattered out of the beam, and part of it may be absorbed in the coating. The rest of the light is transmitted and propagates to the next surface in the optical train. The light that is directly transmitted at each surface and finally arrives at the image surface represents the signal S of our sensor. This signal is given by

S=Σ Tⱼ (1)

Where Tⱼ is the transmittance of the coating on surface j and the summation is over all surfaces in the optical train. The coating at each surface and in particular, surface j, will also have a front-side reflectance Raⱼ and a back-side reflectance Rbⱼ. Except for the very first surface this reflectance diverts the light back to a previous surface where it is again partially reflected back toward the image surface. But such light encounters additional surfaces having curvatures not in accord with the focusing properties of the lens system. Therefore, such multiply reflected light will be out of focus at the image surface. This contributes noise to the signal.

Knowing the transmittance Tⱼ and the reflectances Raⱼ and Rbⱼ for the coatings of each surface, it is possible to ray trace the various paths taken by the multiple reflections to the image surface. Since there are hundreds of such paths, for our modeling purposes we consider a limiting case which provides a solution for the light arriving at the image surface from all the infinite number of multiple reflections. This limiting case is to consider all surfaces as being flat such that all multiple reflections are reduced to two components, one arriving at the image surface and one being reflected back out of the lens system. The equations for this calculation are given in the book, Optical Coating Technology, by Phillip W. Baumeister, SPIE Press, Bellingham, Washington 98227-0010 (2004) in section 10.3.3 Equations for reflectance and transmittance—incoherent illumination found on page 10-20. The known coating properties Tⱼ and the reflectances Raⱼ and Rbⱼ are used to form a two by two matrix for each surface. Multiplying these matrices together for all surfaces enables the calculation of the total light arriving at the image surface from multiple reflections, which we denote as the noise N. Whereas the signal S defined above is a function of only the transmittance Tⱼ of all of the coatings, the noise N is a function of both Tⱼ and the reflectances Raⱼ and Rbⱼ of all the surfaces.

The front side reflectance Raⱼ and back side reflectance Rbⱼ are normally equal and indeed must be equal when there is no absorption in the coating. But when there is absorption in the coating these reflectance values need not be equal. This being the case, conservation of energy implies that the coating absorbs a different amount of light depending on which way the light is propagating through the coating. Thermodynamic considerations require that the transmittance of light must be the same regardless of the direction. But this is not the case with absorption. When scattering can be neglected the absorption for forward propagating light Aaⱼ is calculated from the equation,

Aaⱼ=1−Tⱼ−Raⱼ. (2)

Likewise when light is propagating in the backward direction the absorption in coating j is given by,

Abⱼ=1−Tⱼ−Rbⱼ. (3)

We thus have a principle upon which we may configure the optical coating properties, Tⱼ, Raⱼ, and Rbⱼ for all optical surfaces that can reduce the noise at the image surface due to the multiple reflections and enhance the image contrast and signal to noise ratio.

Establishing the coating properties for each surface j may be accomplished by first calculating the signal S and noise N for some starting configuration with known specified coating properties, Tⱼ, Raⱼ, and Rbⱼ. The calculations are made using Equation (1) above and the matrix equations used to evaluate the noise N. Adjustments to the coating properties are then made to reduce the quantity, N/S, which is the inverse of the signal to noise ratio.

Once the coating properties for each surface j are determined, the realization of a multilayer coating design is developed with straight forward use of thin film design software. One such product is OptiLayer (OptiLayer Thin Film Software is developed by OptiLayer Ltd., Web site: http://www.optilayer.com). There are others as well. It is necessary that the design software have the capability to include targets for front and backside reflectance as well as transmittance so that the coating properties derived above may be achieved. It is also necessary to include as candidate layer materials at least one that has some absorption.

### BRIEF DESCRIPTION OF THE DRAWINGS

In the drawings:

FIG. 1 is a schematic view of a multilayer coating showing the three properties of a coating, the transmittance T, the front side reflectance Ra, and the back side reflectance Rb.

FIG. 2 is a schematic view of the coatings on the lenses showing the intensities of the forward propagating and the back propagating light between the coated surfaces.

FIG. 3 is a plot showing the advantages of using absorption in the optical coatings for Example 1.

FIG. 4 is a plot showing the advantages of using absorption in the optical coatings for Example 2, which uses a different distribution of absorption from Example 1.

### DETAILED DESCRIPTION OF THE INVENTION

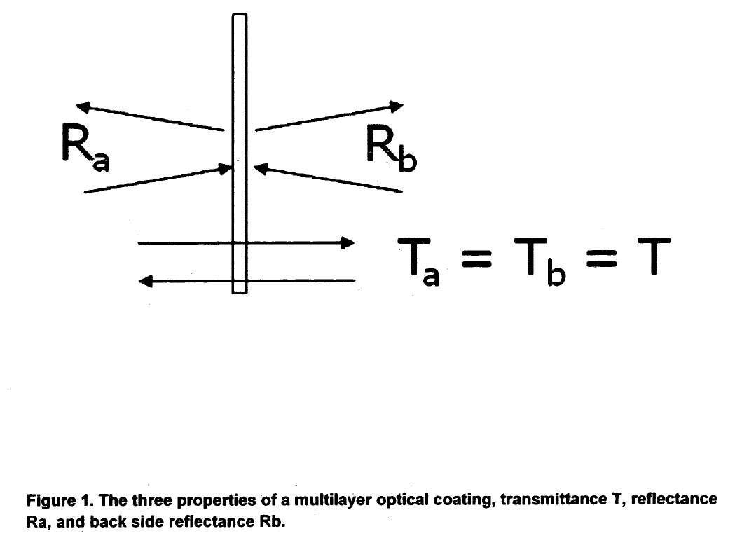

Even though an optical coating on a lens surface may consist of multiple layers, the overall coating on a surface has three optical properties that characterize its performance. These are illustrated in FIG. 1. These are the transmittance T through the coating and surface, the reflectance Ra of light incident from the front side, and reflectance Rb of light incident from the back side. The front and back side refer to the coating and its associated surface itself and not to the front and back side of the lens. Clearly, a lens has two surfaces, so two such coatings and associated surfaces will model a single lens. In this invention, contrary to standard practice, the optical properties coating on the front side of a lens are not necessarily the same as coating on the back side of that lens. We thus assign a letter j, as in Equations (1)-(3), to represent the optical properties of the coating associated with surface j.

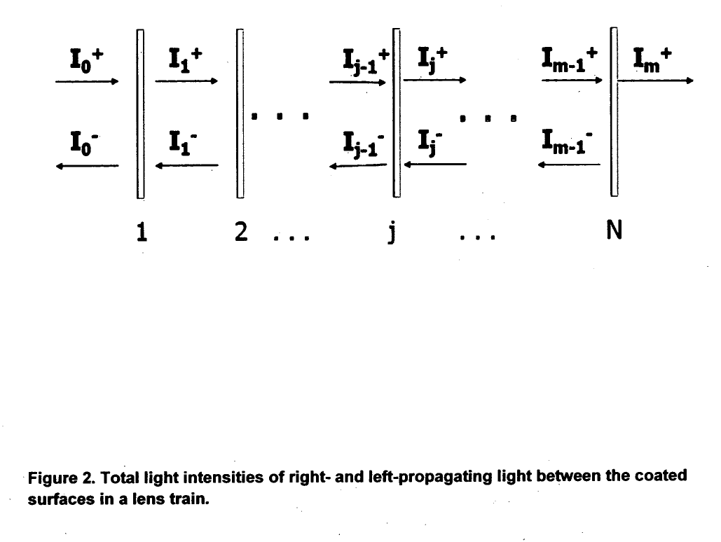

The letter N in FIG. 2 represents the total number of coatings in the lens system. Since there are two coatings on each lens element, there will be N/2 total lenses in the optical train. FIG. 2 also shows the total light intensity occurring between the coatings as it is broken down into two components, one for light traveling to the right, which is designated by a plus sign, and one for light traveling to the left, which is designated by a minus sign.

The coating on the j^{th} surface is shown isolated in FIG. 2. The space to the left of that surface is designated j-1 and the space to the right of is designed at j. To the left of surface 1 is the object space and is designated by the subscript zero. The intensity l₀⁺ is thus the intensity of the the incident light. The intensity l₀⁻ is the total intensity of the light that is reflected back into the object space from the all the surfaces in the lens train. The space to the right of the last coating is the image space. The total intensity of light leaving the lens system is lₘ⁺.

The matrix equations detailed by Baumeister enable the calculation of the total transmittance Tₜₒₜₐₗ=lₘ⁺/l₀⁺ as well as the total reflectance Rₜₒₜₐₗ=l₀⁻/l₀⁺. Thus these quantities become known from the optical properties of all the coatings in the lens train. The total transmittance consists of contributions from all the multiple reflections as well as the light that is not reflected. Thus, Tₜₒₜₐₗ contains both the signal and the noise. The signal portion of this is given in Equation (1) above. This is the light that is transmitted through all surfaces without being reflected. The noise is then just the total transmittance minus the signal. The matrix equations used for this computation are those for the superposition of incoherent light as is the case when distances between coatings are very large compared to the wavelength of light. These are not the matrix equations used for coherent light. Those use what is called the characteristic matrix and are used by the commercial optical design software programs when determining the number of layers and layer thicknesses needed to obtain the desired coating optical properties.

When the signal S and the noise N are know, we compute the signal to noise ratio, S/N and the image contrast C=(S−N)/(S+N). The coating optical properties, Tⱼ, Raⱼ, and Rbⱼ, are changed for all surfaces so as to maximize the signal to noise ratio and the contrast. This is a numerical optimization process which may be performed with computer assistance.

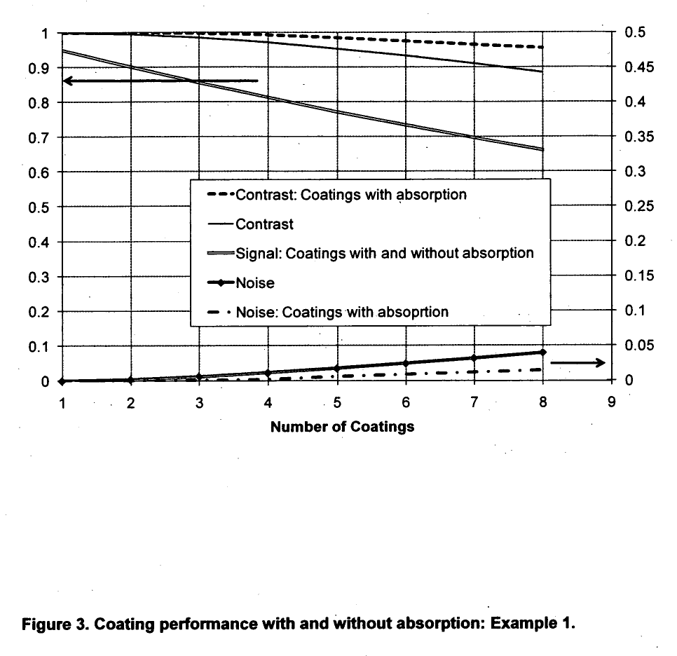

As a first example, we consider the 8 surfaces of a 4 germanium lens system for an infrared sensor. Each uncoated surface transmits 64%. Transmittance through all 8 surfaces if left uncoated will be only 2.71%. Now consider an anti-reflection coating on all 8 surfaces each transmitting 95% with Ra=Rb=5%, which means there is no absorption. The signal is 66.3% and the noise from multiple reflections is 4.1%. This results in a contrast of 88.6% and a signal to noise ratio of 16.5. Next, in accordance with this invention, we introduce absorption into the coatings. We do so in such a way that the transmittance still is 95% for all surfaces, but Ra=0.0125 and Rb=0.0375 for the first four coatings and Ra=0.0375 and Rb=0.0125 for the final four coatings. With these coatings the signal is still 66.3% but the noise from multiple reflections is reduced from 4.1% to 1.5%. This produces a contrast of 95.6% and a signal to noise ratio of 44.3. The signal, contrast, and signal to noise ratio are show plotted in FIG. 3 as a function of the number of coatings encountered by the light. FIG. 3 shows these quantities for both with and without absorption in the coatings.

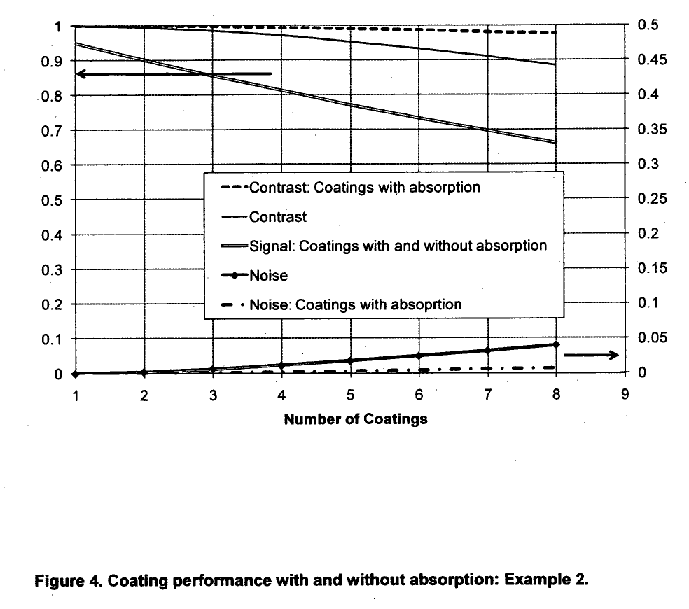

As a second example we consider the coatings in the following arrangement. The transmittance still is 95% for all surfaces and Ra=0.0125 and Rb=0.0375 for all of the 8 coatings. With these coatings the signal is still 66.3% but the noise from multiple reflections is reduced from 4.1% without absorption to 0.8% with absorption in the coatings. This results in a contrast of 97.8% and a signal to noise ratio of 90.9. The signal, contrast, and signal to noise ratio are show plotted in FIG. 4 as a function of the number of coatings encountered by the light. FIG. 4 shows these quantities for both with and without absorption in the coatings.

### DISCUSSION

The first example shown above illustrates the advantage of using absorption in the surface coatings to reduce the multiple reflections and enhance the contrast and signal to noise ratio. The second example illustrates the improvement realized when the absorption is more favorable distributed in the optical coating. It is apparent to one skilled in the art of coating design that other values of the coating properties will provide even further improvements in contrast and signal to noise. Both examples shown had the same total transmittance as the coatings without absorption, which was done for illustration. In general other values of total transmittance can also show beneficial effects of adding absorption to the coatings.

With the principles of this invention, that is the use of absorption in the surface optical coatings, other benefits may be realized. These include reducing the effects image noise due to surface scattering, such as dust or surface scratches. Another benefit is that the back reflection from the lens system may be reduced or controlled. Total back reflection is also calculated using the same incoherent matrix equations described above and is therefore subject to changes in the distribution of absorption in the coating chain.

Other applications and embodiments of this invention will become apparent to those skilled in the art. Implementations such as the numerical methods used to obtain the coating optical properties or the methods used to realize the multilayer coating designs having these optical properties are all considered within the domain of this invention.

1. A method for reducing the image noise due to multiple reflections from lens surfaces by introducing absorption into the coatings on said lens surfaces.

2. The method of claim 1 wherein the lens coating properties include front side reflectance that differs from back side reflectance.

3. The method of claim 1 wherein the lens coating properties are such that the light absorption from light going through the coating in one direction differs from the light absorption going through the coating in the opposite direction.

4. The method of claim 1 wherein the image contrast and signal to noise ratio are increased by the use of absorption in the lens coatings.

5. A method for reducing the image noise resulting from surface scattering by the use of absorption in the optical coatings.

6. A method for reducing the total back reflected light from a lens system by the use of absorption in the optical coatings on the surfaces of said lens system.

7. The method of claim 6 wherein the lens coating properties include front side reflectance that differs from back side reflectance.

8. The method of claim 6 wherein the lens coating properties are such that the light absorption from light going through the coating in one direction differs from the light absorption going through the coating in the opposite direction.

9. An optical coating for lens surfaces that is partially absorbing that will reduce the amount of multiple reflected light that reaches the image surface.

10. The optical coating of claim 9 that has the property that its reflection from the front side differs from its reflection from the back side.

11. The optical coating of claim 9 that has the property that its absorption for light entering from one direction differs from the its absorption for light entering from the other direction.

12. The optical coating of claim 9 that will act as an anti-reflection coating as well as enhance the contrast and signal to noise ratio of the image.

13. The optical coating of claim 9 consisting of a single or multiple layers of high refractive index optical layers and/or low refractive index optical layers and which includes an absorbing layer or layers which may consist of metals or metal nitrites or other absorbing materials.

14. The optical coating of claim 9 consisting of multiple layers of optical materials and which includes an absorbing layer or layers which may consist of metals or metal nitrites or other absorbing materials and whose layer thicknesses are determined by optimization so as to adhere to specified transmittance and front side reflection and backside reflection which has been specified so as to reduce the total amount of multiple reflected light reaching the image surface.

15. A set of optical coatings of claim 9 whose optical properties may differ for each surface in an optical train but which will work in concert to reduce the amount of multiple reflected light that reaches the image surface.

16. An optical coating for reducing the image noise resulting from surface scattering by the use of absorption in the optical coatings.

17. An optical coating for reducing the total light back reflected from a lens system which incorporates absorption in the optical coatings on the lens surfaces.
